(19) United States
(12) Patent Application Publication
(10) Pub. No.: US 2014/0103016 A1
(43) Pub. Date: Apr. 17, 2014

(54) Induction Bend Cutting System

(71) Applicant: Hypertherm, Inc., Hanover, NH (US)

(72) Inventors: Michael Tracy Ward, Monticello, AR (US); Jerry Wayne Ebert, Monticello, AR (US); Gerald Wade Beck, Monticello, AR (US); Bruce Peter Altobelli, Etna, NH (US)

(73) Assignee: Hypertherm, Inc., Hanover, NH (US)

(21) Appl. No.: 14/051,740

(22) Filed: Oct. 11, 2013

Related U.S. Application Data
(60) Provisional application No. 61/712,469, filed on Oct. 11, 2012.

(51) Int. Cl. B23K 37/047; B23K 37/02; B23K 10/00

(52) U.S. Cl. CPC B23K 37/047; B23K 10/00; B23K 37/0276
USPC 219/121.39; 219/121.56; 219/121.44

(57) ABSTRACT

The invention features methods and apparatuses for cutting a section of a pipe having a non-linear longitudinal axis. A mounting structure attaches to a first portion of the pipe. A track is connected to the mounting structure and defines a drive plane. A moveable structure is coupled to the track and configured to move circumferentially along the track. A tool holder is connected to the moveable structure and positions a cutting tool relative to a cutting plane in a second portion of the section of pipe, the cutting plane substantially perpendicular to the non-linear longitudinal axis at a cutting location on the pipe. The mounting structure adjusts to position the track such that the drive plane is parallel to the cutting plane, separated from the cutting plane, substantially non-perpendicular to the non-linear longitudinal axis at the first portion on the pipe.

### CROSS-REFERENCE TO RELATED APPLICATION

This application claims the benefit of U.S. Provisional Patent Application No. 61/712,469, which was filed on Oct. 11, 2012 and entitled “Induction Bend Cutting System,” the entire contents of which are hereby incorporated herein by reference.

### FIELD OF THE INVENTION

The invention relates generally to the field of plasma cutting systems and processes. More specifically, the invention relates to methods and apparatuses for cutting pipes with non-linear axes at desired angles by clamping securely to a pipe and adjustably positioning a cutting torch at a chosen orientation.

### BACKGROUND

Plasma arc torches are widely used in the cutting and marking of materials. A plasma torch generally includes an electrode and a nozzle having a central exit orifice mounted within a torch body, electrical connections, passages for cooling, and passages for arc control fluids (e.g., plasma gas). The torch produces a plasma arc, a constricted ionized jet of a gas with high temperature and high momentum. Gases used in the torch can be non-reactive (e.g., argon or nitrogen) or reactive (e.g., oxygen or air). During operation, a pilot arc is first generated between the electrode (cathode) and the nozzle (anode). Generation of the pilot arc can be by means of a high frequency, high voltage signal coupled to a DC power supply and the torch or by means of any of a variety of contact starting methods.

Known plasma pipe cutting systems are ill-suited to cut induction bends or other pipes with non-linear axes. These systems typically clamp onto a pipe and cut at a location spaced a distance from the clamp location. The curvature of the pipe between the clamp location and cutting location can cause the cut to be made at an undesirable angle (e.g. an angle of the cutting plane not substantially perpendicular to the pipe axis at the cutting location). In addition, these systems are not typically suited to create a bevel during cutting, instead requiring a separate beveling operation to be performed after the cut is made. Thus, cutting and/or beveling pipes with non-linear axes can be a difficult and time-intensive task.

### SUMMARY OF THE INVENTION

The present invention addresses the unmet need for a cutting system that both clamps securely to a pipe with a nonlinear axis and allows the operator to adjust and secure the cutting system at a desired angle. When fitted with a cutting torch, the system provides predictable cuts of curved pipes at desired angles (e.g. where the cutting plane is perpendicular to the pipe axis at the cutting location) in a short time frame. The system also allows a precise bevel to be produced via the same cutting operation. The system also allows a number of cutting tools to be used, e.g. an oxy torch, disc blade cutting device, and/or a plasma torch.

In one aspect, the invention features an apparatus for cutting a section of a pipe having a non-linear longitudinal axis. The apparatus comprises a mounting structure attachable to a first portion of the section of pipe. A track is connected to the mounting structure. The track defines a drive plane relative to the first portion of the section of pipe. A moveable structure is coupled to the track and configured to move about the pipe circumferentially along the track. A tool holder is connected to the moveable structure and positions a cutting tool relative to a cutting plane in a second portion of the section of pipe. The cutting plane is at least substantially perpendicular to the non-linear longitudinal axis at a cutting location on the pipe. The mounting structure is adjustable to position the track such that the drive plane is parallel to the cutting plane, separated from the cutting plane by a specified distance, and/or substantially non-perpendicular to the non-linear longitudinal axis at the first portion on the section of pipe.

In some embodiments, the mounting structure includes an alignment feature that is adjustable relative to the mounting structure. In some embodiments, the mounting structure includes an alignment feature that is fixed relative to the mounting structure. In some embodiments, a first alignment feature is located on a forward side of the mounting structure and a second alignment feature is located on a rearward side of the mounting structure. In some embodiments, an alignment feature includes a rubber pad. In some embodiments, an alignment feature includes a ball bearing. In some embodiments, an alignment feature includes a roller block.

In some embodiments, the mounting structure includes at least one alignment device positioned to align the mounting structure relative to the cutting plane. In some embodiments, the tool holder includes a height controller to adjust the height of the cutting tool above the pipe. In some embodiments, the tool holder is positionable at least (i) perpendicularly to the longitudinal axis of the pipe; (ii) facing toward the drive plane and forming an acute angle relative to the longitudinal axis of the pipe; or (iii) facing away from the drive plane and forming an obtuse angle relative to the longitudinal axis of the pipe.

In some embodiments, the moveable structure is a motorized trolley. In some embodiments, the mounting structure has a substantially circular shape. In some embodiments, the mounting structure includes an anvil type clamp, the track pivotable relative to the anvil type clamp. In some embodiments, the mounting structure is positioned between the track and the pipe and is capable of adjusting the position of the track relative to the pipe.

In another aspect, the invention features a method for cutting a section of a pipe having a non-linear longitudinal axis. A cutting plane is defined relative to a second portion of the section of pipe. The cutting plane is at least substantially perpendicular to the longitudinal axis of the section of pipe at a cutting location on the pipe. A cutting tool is provided for cutting the pipe in the cutting plane. A track is provided for driving the cutting tool circumferentially around a cross-sectional perimeter of the pipe. The track is affixed to a first portion of the section of pipe, the track defining a drive plane relative to the first portion of the section of pipe and separated from the cutting plane by a specified distance. A mounting structure is adjusted to position the track such that the drive plane is oriented parallel to the cutting plane. The cutting tool is positioned relative to the cutting plane to cut the pipe. The pipe is cut.

In some embodiments, the pipe is leveled relative to a ground plane. In some embodiments, the track is leveled relative to a vertical plane. In some embodiments, a plurality of alignment features are provided, at least some of which are adjustable to align the cutting plane relative to the pipe. In some embodiments, a lasing device is positioned relative to the cutting plane to align the cutting tool relative to the pipe. In some embodiments, the tool holder is positioned at an angle relative to the cutting plane to produce a bevel cut.

In some embodiments, the height of the tool holder is adjusted above the pipe. In some embodiments, defining a cutting plane comprises adjusting an alignment feature connected to the track to position the track relative to the pipe. In some embodiments, defining a cutting plane comprises pivoting the track relative to a mounting structure affixed to the pipe at a spaced distance from the track.

In another aspect, the invention features an apparatus for cutting a curved section of pipe. The apparatus comprises a track positioned relative to a first portion of the section of pipe, the track defining a drive plane relative to the first portion. A moveable means is coupled to the track and configured to move circumferentially along the track. A tool means is connected to the moveable structure for positioning a cutting tool relative to a cutting plane in a second portion of the section of pipe, the cutting plane being separate from the drive plane by a specified distance. An adjustment means is mechanically coupled to the track. The adjustment means is adjustable to position the track such that (i) the drive plane is parallel to the cutting plane and/or (ii) the cutting plane is at least substantially perpendicular to the non-linear longitudinal axis at a cutting location on the section of pipe.

In some embodiments, the adjustment means comprises a plurality of alignment features. In some embodiments, the tool means is capable of positioning the cutting tool to produce at least one of an inward bevel, an outward bevel, or a square cut.

### BRIEF DESCRIPTION OF THE DRAWINGS

The foregoing discussion will be understood more readily from the following detailed description of the invention when taken in conjunction with the accompanying drawings.

FIGS. 1A-1C are illustrations of an induction bend cutting system positioned on a curved pipe, according to an illustrative embodiment of the invention.

FIG. 2 is an illustration of an induction bend cutting system having a plurality of alignment features, according to an illustrative embodiment of the invention.

FIG. 3 is an illustration of an induction bend cutting system having an anvil and a pivot, according to an illustrative embodiment of the invention.

### DETAILED DESCRIPTION OF THE DRAWINGS

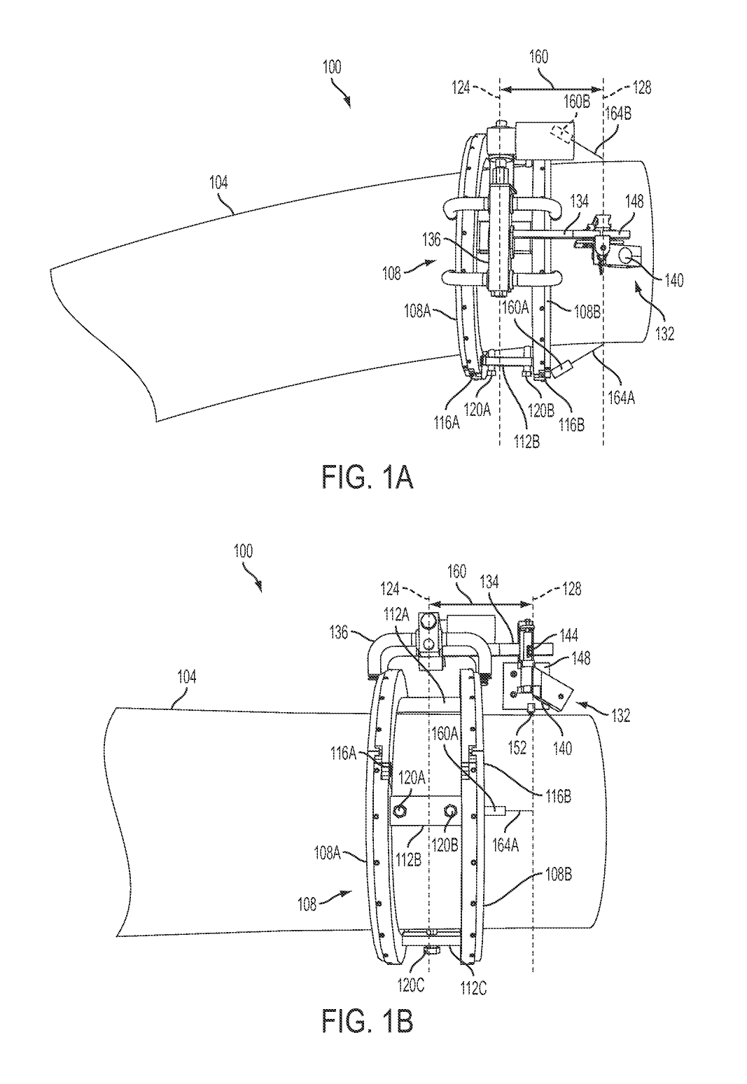

FIGS. 1A-1C are illustrations of an induction bend cutting system 100 positioned on a curved pipe 104, according to an illustrative embodiment of the invention. FIG. 1A shows a top view of the system 100. FIG. 1B shows a side view of the system 100. FIG. 1C shows a perspective view of the system 100. Reference is made to FIGS. 1A-1C collectively, with certain views of the system 100 showing particular components of the system 100.

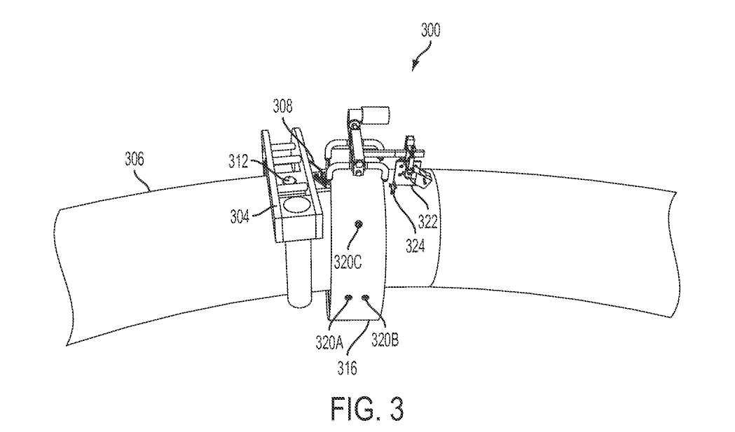

The system 100 includes a track 108 comprising rings 108A, 108B. The rings 108A, 108B can be circular or substantially circular. The rings 108A, 108B can have a diameter that is larger than a cross-sectional diameter of the section of pipe 104. The rings 108A, 108B can be made of a flexible material (e.g. metal) that can be conformed to a range of cross-sectional pipe geometries (e.g. circles, ovals, etc). The ring 108A can be connected to the ring 108B, e.g. by metallic members 112A-C. In some embodiments additional metallic members are used to connect the rings 108A, 108B. The rings 108A, 108B can comprise two sections joined by ring pins 116A, 116B and pivot around ring pins 116A, 116B. The rings 108A, 108B can open to receive the pipe 104 and can be clamped securely around the pipe 104. In some embodiments a quick latch (not shown) is used to secure the rings 108A, 108B into position on the pipe 104. In some embodiments, a bubble level (e.g. bubble level 312 as shown below in reference to FIG. 3) is used to level the rings 108A, 108B with respect to a ground plane (not shown).

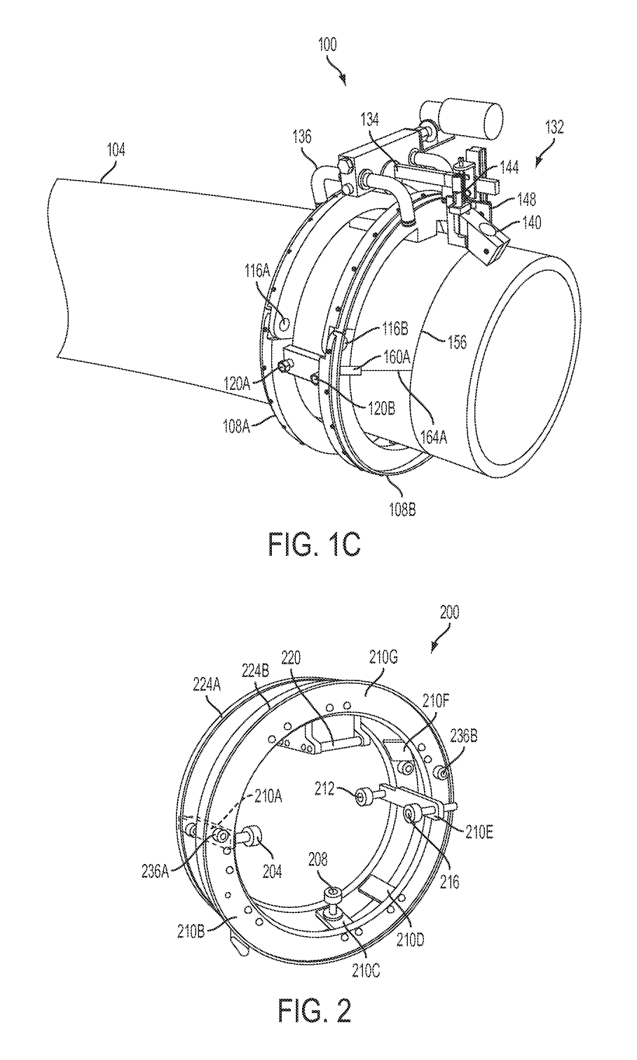

The track 108 can define a drive plane 124. The drive plane 124 can be orthogonal to a ground plane (not shown). The drive plane 124 can be located between the rings 108A, 108B (e.g. halfway between the rings 108A, 108B). The track 108 can be positioned such that the drive plane 124 is not substantially perpendicular to a longitudinal axis of the pipe 104 where the track 108 is mounted to the pipe 104. In some embodiments the metallic member 112B forms a mounting structure that allows the track 108 to be adjustably positioned relative to a first portion of the pipe 104. The metallic member 112B can be fitted with alignment features 120A, 120B. The alignment features 120A, 120B can be adjustable to position the track 108 at an angle (e.g. not substantially perpendicular) relative to a longitudinal axis of the pipe 104. In some embodiments the alignment features 120A, 120B are screws. The metallic member 112C can also be fitted with an alignment feature 120C (e.g. a screw). In some embodiments the alignment features 120A-120C include other components as described below in reference to FIG. 2.

In some embodiments, a cut line 156 (as shown in FIG. 1C) is drawn on a second portion of the pipe 104 by an operator. To draw the cut line 156, reference points can be marked on the exterior of the pipe 104. A first reference point can be marked on an outer bend circumference of the pipe 104 (e.g. the upper of the two edges shown in FIG. 1A). A second reference point can be marked on an inner bend circumference of the pipe 104 (e.g. the lower of the two edges shown in FIG. 1A). In some embodiments a table of chords and/or arc lengths can be used to assist the operator in marking the reference points in appropriate positions. A guide can be used to connect the reference points and complete the cut line 156. The cut line 156 can define a cutting plane 128 in the second portion of the pipe 104 (as shown in FIGS. 1A and 1B), e.g. a plane in which the pipe 104 is to be cut using the system 100.

The ring 108B can include laser alignment devices 160A, 160B. In some embodiments, the laser alignment devices 160A, 160B are laser pointers. The laser alignment devices 160A, 160B can be located at opposite ends of a diameter of the ring 108B. The laser alignment devices 160A, 160B can generate laser beams 164A, 164B, respectively. The laser alignment devices 160A, 160B can be positioned at an angle with respect to a longitudinal axis of the pipe 104 such that laser beams 164A, 164B strike the pipe 104 in the cutting plane 128. An operator can adjustably position the track 108 using at least alignment features 120A, 120B such that laser beams 164A, 164B each strike the cut line 156, e.g. as show in FIG. 1A. When beams 164A and 164B strike the cut line 156 the induction bend cutting system 100 is aligned to cut the pipe 104 on the cut line 156, e.g. a line where the pipe 104 intersects the cutting plane 128.

The drive plane 124 can be parallel to the cutting plane 128. The cutting plane 128 can be spaced a specified distance 160 from the drive plane 124. In some embodiments the specified distance 160 can be between two and twelve inches. In some embodiments the specified distance 160 can be between three and ten inches. In some embodiments the specified distance 160 can be between four and eight inches. In some embodiments the specified distance 160 is defined by and/or dependent on a length of the metallic member 134. In some embodiments the specified distance 160 can be long enough to ensure that the cutting device is far enough away from the rings 108A, 108B that torch holder 132 can swing into either an inward or outward bevel cut position. In some embodiments the specified distance 160 is long enough such that the cutting device does not to interfere with the cutting operation, e.g. so the torch does not cut the track 108 or other system components inadvertently. In some embodiments the specified distance 160 is long enough such that the torch holder 132 can be positioned to perform either an inward or outward bevel. In some embodiments the specified distance 160 is short enough such that a torch height controller 148 (described in detail below) does not suffer from too much bend in the metallic member 134.

A movable structure 136 is coupled to the track 108. In some embodiments the movable structure 136 is a motorized trolley. In some embodiments the trolley is a Monarch Crawler manufactured by Mathey Dearman or a manual crawler. The movable structure 136 is configured to move circumferentially along the track 108 in the drive plane 124. A torch holder 132 is connected to the movable structure 136 via a metallic member 134. The torch holder 132 includes an orifice 140 into which a torch (not shown) can be inserted. The torch holder 132 can be positioned at an angle relative to a cross sectional radial direction of the pipe 104, allowing a bevel cut to be made. The torch holder 132 can be positioned to provide an inward bevel cut (as shown in FIGS. 1A-1C). The position of the torch holder 132 can be adjusted to provide an outward bevel cut (e.g. flipped 180 degrees along the direction of the pipe axis where the torch holder 132 is located). The torch holder 132 can be positioned to provide a square cut (e.g. no bevel). The movable structure 136 can power the torch holder 132 circumferentially around the pipe 104. The torch performs the cut as the torch holder 132 is powered around the pipe 104. A 360 degree rotation of the movable structure 136 around the longitudinal axis of the pipe 104 can complete a cut of the pipe 104. The torch can be a plasma cutter, a laser torch, or another kind of cutting device.

The torch holder 132 is connected to a torch height controller 148. The torch height controller 148 can control the height of the torch relative to an exterior surface of the pipe 104. In some embodiments a spring loaded lock bolt 144 is used to control the torch height relative to the pipe 104, e.g. the torch can be spring loaded to bias the torch relative to the pipe 104 to account for imperfections in the pipe 104 and/or the bend in the pipe 104. In some embodiments the spring loaded lock bolt 144 secures the torch holder 132 in place. The torch height controller 148 can follow a non-linear path around the exterior of the pipe 104. In some embodiments the torch height controller 148 comprises a torch plate, e.g. a substantially square metallic plate as show in FIGS. 1A-1C.

In some embodiments a ski member 152 is attached to the torch height controller 148. The ski member 152 can guide the torch in its rotation around the pipe 104 and/or assist the torch height controller 148 in maintaining the proper height above the exterior of the pipe 104. In some embodiments a better cut result is obtained when the ski member 152 is closer to the cut line. In some embodiments the ski member 152 is made from PolyTetraFluoroEthylene (“PTFE”). In some embodiments the ski member 152 is made of stainless steel. In some embodiments the ski member 152 reduces variance of the bevel, eliminates heat damage, and/or allows the torch to be positioned in close proximity to the pipe 104.

FIG. 2 is an illustration of an induction bend cutting system 200 having a plurality of alignment features 204, 208, 212, 216, 220, according to an illustrative embodiment of the invention. A plurality of metallic members 210A-210G can be attached to rings 224A, 224B and/or used to connect the rings 224A, 224B. The alignment feature 204 can be attached to the metallic member 210A (obscured, shown with dotted lines) connecting the rings 224A, 224B. The alignment feature 204 can be centered on the metallic member 210A between the rings 224A, 224B. The alignment feature 204 can be stationary with respect to the metallic member 210A and/or the rings 224A, 224B. The alignment feature 204 can be positioned 90 degrees counter-clockwise around the rings 224A, 224B with respect to a reference point 228 located at a zenith of the rings 224A, 224B with respect to a ground plane (e.g. in a “9 o'clock” position on rings 224A, 224B). In some embodiments the alignment feature 204 comprises a rubber pad. When the system is clamped onto a pipe (not shown), the rubber pad can grip the pipe to prevent slipping. The rubber pad can have a diameter of about 1.75 inches. In some embodiments the rubber pad is mounted on a swivel ball such that it can be positioned normal to the pipe.

A further metallic member 210C can join the rings 224A, 224B. An alignment feature 208 can be attached to the metallic member 210C and/or positioned to contact the pipe. The alignment feature 208 can include a ball bearing. During a cutting operation the alignment feature 208 can contact the pipe at a single point. The single point of contact can maximize stability of the induction bend cutting system 200 when the system 200 is clamped to the pipe (e.g. the sturdiness with which the system 200 is clamped to the pipe). The alignment feature 208 can be positioned 180 degrees around the rings 224A, 224B with respect to reference point 228 (e.g. in a “6 o'clock” position with respect to the rings 224A, 224B). The alignment feature 208 can be centered on the metallic member 210. In some embodiments the alignment feature 208 is stationary with respect to the rings 224A, 224B. In some embodiments the alignment feature 208 is adjustable with respect to the rings 224A, 224B (e.g. can move toward and away from the center of the rings 224A, 224B, e.g. via an adjustable screw).

A further metallic member 210E can be attached to the rings 224A, 224B. The metallic member 210E can be attached to further alignment features 212, 216. The alignment features 212, 216 can each contact a pipe during a cutting operation of the system 200. In some embodiments, each alignment feature 212, 216 can contact the pipe at a single point of contact. The alignment features 212, 216 can be positioned 270 degrees counter-clockwise from reference point 228 (e.g. in a “3 o'clock” position with respect to rings 224A, 224B). The alignment feature 212 can be positioned to the left of the center of the metallic member 210E. The alignment feature 216 can be positioned to the right of center of the metallic member 210E. The alignment features 212, 216 can each be independently adjustable with respect to the metallic member 210E. (e.g. in a direction toward and/or away from the pipe axis). Adjusting alignment features 212, 216 can pivot the system 200 about a point of contact of alignment feature 204 with the pipe, allowing the system 200 to be oriented as desired with respect to a longitudinal axis of the pipe. The alignment features 212, 216 can include ball bearings. Using ball bearings can allow the system to rotate easily about a pivot point defined by alignment feature 204.

The alignment feature 220 can be attached to the rings 224A, 224B. The alignment feature 220 can include a roller block. The alignment feature 220 can contact the pipe at and/or near a highest point on the pipe (e.g. in a “12 o'clock” position with respect to the rings 224A, 224B). The alignment feature 220 can allow the system 200 to translate easily to a desired location along the pipe. The roller block 220 can have two rollers, e.g. one on the front and one on the rear. In some embodiments the rollers are parallel to each other. The roller block 220 can ensure that the system is level, as confirmed by a bubble level mounted on the top of the system 200. Laser alignment devices 236A, 236B can be attached to the ring 224B. The laser alignment devices 236A, 236B can be angled such that they strike a cut line when the system 200 is positioned on the pipe (e.g. cut line 156 as shown above in reference to FIG. 1C).

FIG. 3 is an illustration of an induction bend cutting system 300 having an anvil 304 and a pivot 308, according to an illustrative embodiment of the invention. The system 300 can include substantially similar components to the system 100 described above with respect to FIGS. 1A-1C and/or the system 200 described above with respect to FIG. 2. In some embodiments the system 300 uses different mounting and alignment components than the systems 100, 200.

The system 300 can include an anvil 304. The anvil 304 clamps securely to the pipe 306. The anvil 304 can include a flat top, one rounded side, and/or one flat side. The anvil 304 can be adjustable to fit a range of radii of the pipe 306. The anvil 304 can include a bubble level 312 to indicate when the anvil 304 is aligned with respect to the horizontal (e.g. a plane parallel to a ground plane). The anvil 304 can include a magnetic member (not shown) to help ensure proper alignment of the anvil 304 on the pipe 306. The anvil 304 can self-align to a desired orientation when clamped into position.

The anvil 304 connects to a band 316 that floats around the pipe 306. The band 316 can be positioned at an angle relative to the anvil 304 and/or a longitudinal axis of the pipe 306. Beneath the band 316 are rings (not shown), e.g. rings 108A, 108B as described above with respect to FIGS. 1A-1C. The band 316 can be attached to a calibration lock bolt 308. An angle can be chosen to provide a cut line perpendicular to the longitudinal axis of the pipe 306. The angle can be selected by adjusting the calibration lock bolt 308 to a desired position. The band 316 can include stabilization screws 320A-320C. The stabilization screws 320A-320C can be used to secure the band 316 to the pipe 306. In some embodiments additional stabilization screws can be used. In some embodiments, a metallic member including a wheel 324 can be attached to the torch plate 322 (e.g. torch plate 148 as described above with respect to FIGS. 1A-1C). The remaining components of the system 300 can be similar to the components described above with respect to FIGS. 1A-1C and/or FIG. 2.

While the invention has been particularly shown and described with reference to specific preferred embodiments, it should be understood by those skilled in the art that various changes in form and detail may be made therein without departing from the spirit and scope of the invention as defined by the following claims.

What is claimed is:

1. An apparatus for cutting a section of a pipe having a non-linear longitudinal axis, the apparatus comprising:
a mounting structure attachable to a first portion of the section of pipe;
a track connected to the mounting structure, the track defining a drive plane relative to the first portion;
a moveable structure coupled to the track and configured to move about the pipe circumferentially along the track; and
a tool holder, connected to the moveable structure, for positioning a cutting tool relative to a cutting plane in a second portion of the section of pipe, wherein the cutting plane is at least substantially perpendicular to the non-linear longitudinal axis at a cutting location on the pipe;
wherein the mounting structure is adjustable to position the track such that the drive plane is (i) parallel to the cutting plane, (ii) separated from the cutting plane by a specified distance, and (iii) substantially non-perpendicular to the non-linear longitudinal axis at the first portion of the section of pipe.

2. The apparatus of claim 1 wherein the mounting structure includes an alignment feature that is adjustable relative to the mounting structure.

3. The apparatus of claim 1 wherein the mounting structure includes an alignment feature that is fixed relative to the mounting structure.

4. The apparatus of claim 1 further comprising a first alignment feature located on a forward side of the mounting structure and a second alignment feature located on a rearward side of the mounting structure.

5. The apparatus of claim 1 further comprising an alignment feature including a rubber pad.

6. The apparatus of claim 1 further comprising an alignment feature including a ball bearing.

7. The apparatus of claim 1 further comprising an alignment feature including a roller block.

8. The apparatus of claim 1 wherein the mounting structure includes at least one alignment device positioned to align the mounting structure relative to the cutting plane.

9. The apparatus of claim 1 wherein the tool holder includes a height controller to adjust the height of the cutting tool above the pipe.

10. The apparatus of claim 1 wherein the tool holder is positionable at least (i) perpendicular to the longitudinal axis of the pipe; (ii) facing toward the drive plane and forming an acute angle relative to the longitudinal axis of the pipe; or (iii) facing away from the drive plane and forming an obtuse angle relative to the longitudinal axis of the pipe.

11. The apparatus of claim 1 wherein the moveable structure is a motorized trolley.

12. The apparatus of claim 1 wherein the mounting structure has a substantially circular shape.

13. The apparatus of claim 1 wherein the mounting structure includes an anvil type clamp, the track pivotable relative to the anvil type clamp.

14. The apparatus of claim 1 wherein the mounting structure is positioned between the track and the pipe and is capable of adjusting the position of the track relative to the pipe.

15. A method for cutting a section of a pipe having a non-linear longitudinal axis, the method comprising:
defining a cutting plane relative to a second portion of the section of pipe, the cutting plane at least substantially perpendicular to the longitudinal axis of the section of pipe at a cutting location on the pipe;
providing a cutting tool for cutting the pipe in the cutting plane;
providing a track for driving the cutting tool circumferentially around a cross-sectional perimeter of the pipe;
affixing the track to a first portion of the section of pipe, the track defining a drive plane relative to the first portion of the section of pipe and separated from the cutting plane by a specified distance;
adjusting a mounting structure to position the track such that the drive plane is oriented parallel to the cutting plane;
positioning the cutting tool relative to the cutting plane to cut the pipe; and
cutting the pipe.

16. The method of claim 15 further comprising leveling the pipe relative to a ground plane.

17. The method of claim 15 further comprising leveling the track relative to a vertical plane.

18. The method of claim 15 further comprising providing a plurality of alignment features, at least some of which are adjustable to align the cutting plane relative to the pipe.

19. The method of claim 15 further comprising positioning a lasing device relative to the cutting plane to align the cutting tool relative to the pipe.

20. The method of claim 15 further comprising positioning the tool holder at an angle relative to the cutting plane to produce a bevel cut.

21. The method of claim 15 further comprising adjusting the height of the tool holder above the pipe.

22. The method of claim 15 wherein defining a cutting plane comprises adjusting an alignment feature connected to the track to position the track relative to the pipe.

23. The method of claim 15 wherein defining a cutting plane comprises pivoting the track relative to a mounting structure affixed to the pipe at a spaced distance from the track.

24. An apparatus for cutting a curved section of pipe, the apparatus comprising:
a track positioned relative to a first portion of the section of pipe, the track defining a drive plane relative to the first portion;
a moveable means coupled to the track and configured to move circumferentially along the track;
a tool means connected to the moveable structure for positioning a cutting tool relative to a cutting plane in a second portion of the section of pipe, the cutting plane being separate from the drive plane by a specified distance; and
adjustment means mechanically coupled to the track and being adjustable to position the track such that (i) the drive plane is parallel to the cutting plane and (ii) the cutting plane is at least substantially perpendicular to the non-linear longitudinal axis at a cutting location on the section of pipe.

25. The apparatus of claim 24 wherein the adjustment means comprises a plurality of alignment features.

26. The apparatus of claim 24 wherein the tool means is capable of positioning the cutting tool to produce at least one of an inward bevel, an outward bevel, or a square cut.
